(19) United States
(12) Patent Application Publication
(10) Pub. No.: US 2001/0031450 A1
(43) Pub. Date: Oct. 18, 2001

(54) The 4TH R

(76) Inventor: Sajid A.M. Khan, Ridgefield Park, NJ (US)

Correspondence Address: SAJID ALI MIRZA KHAN, 2 UNION PLACE, RIDGEFIELD PARK, NJ, 07660, US

(21) Appl. No.: 09/754,976

(22) Filed: Jan. 5, 2001

Related U.S. Application Data
(60) Provisional application No. 60/143,668, filed on Jul. 14, 1999.

(51) Int. Cl. G09B 19/00

(52) U.S. Cl. 434/156

(57) ABSTRACT

The 4TH R is a new subject that teaches success. Making informal education formal is the form of a subject. Providing a second chance of a healthy upbringing. Providing the knowledge to every student to master his/her emotional intelligence.

We have long been told that the essential ingredients of a sound education are the 3Rs-Reading, Riting and Rithmetic. I suggest the 4TH R of reality must be added to this list. There are two questions that come to mind. Why reality and can it be taught as a subject?

The human mind works in images. We grow up creating images of ourselves others and the world depending on our early childhood experiences creating our own personal reality by which we live. When our personal reality matches the actual reality out there we succeed. When our personal reality is different from the actual reality we fail. The correct perception of reality is the key ingredient that determines success or failure in life.

It is informal education that we receive in the form of our upbringing that determines our personal reality by which we live and our personal reality determines our emotional intelligence. This is why teaching students the reality about themselves, others and how things work in the real world is so important.

Can reality be taught as a subject? I think so. I have created this new subject that provides each student the chance of a second upbringing, an opportunity to reshape his/her emotional intelligence. The 4TH R will cover topics that will help the student to pause and reflect on his own structure of reality. Curriculum will be provided to improve the student's self-worth and self-respect in concrete terms. Students will be made to understand their emotional problems and shown how to overcome them. The way we currently teach is in an emotional vacuum. This results in students being informed but not being able to master their emotions. The difference between information and knowledge is the emotional intelligence difference. There is a deep emotional component of knowledge which is missing in our current educational system. The difference between cramming information and understanding life is the emotional fusion formed during early childhood. At that early stage of life memories are forgotten while emotions are sealed in. The 4TH R will provide the means to unseal these fused emotions.

Even some fundamental notions on which our student's emotional intelligence is based will be put to the litmus test of reality. Take self-confidence for instance: the notion that you can if you think you can is essential to success but not sufficient to succeed. There are other factors needed to succeed, like learning the ropes and practice, etc. No wonder the self-esteem movement of the 80's has run out of steam because it is based on encouraging overconfidence. Students will be discouraged from building overconfidence and will be given the knowledge to gain self-respect with full faith in their own potential. Lessons will be taught how to develop their full potential by learning and practicing the ropes of life rather than creating a bloated self-confidence by empty praise. Students will be shown the difference between confidence in ones own self and confidence in ones ability in some chosen field.

There will be a full chapter devoted to understanding others. A complete insight in understanding ones own self goes a long way in understanding others. Students will be shown how to decipher the behavior of others. They will be shown how to develop loving and respectful relationships. Why humility is a sign of great emotional intelligence. The student will become an expert on human behavior not only living a happy and successful life; but also understanding and helping those less fortunate with a messed up emotional intelligence.

A whole chapter will be devoted to understanding human nature. At birth every newborn child feels omnipotent and omnipresent. Its mind is so subjective that it has no idea of the outside world. It considers itself as all existence. It feels as if it alone is there. Gradually as it grows old it realizes that there are others. This brings in feelings of fear, jealousy, hate, etc. Basic human nature is formed because the child has to give up these feeling of omnipotence and omnipresence. The student is made to realize where these basic human nature traits are coming from. These are traits that we learn at the earliest stage of our mental development. Each student will be shown why he/she feels the way he/she does. The student will be shown how to master and control his/her basic human instincts.

There will be a full chapter on understanding the human mind. Not as a concept but as it applies to each student personally. The first stage is the pre-mature mind—the mind at birth. At this early stage the self-image of each new born is that of omnipotence and omnipresence. At this stage every student considers himself/herself all-important. All others have no importance as they don't even exist in the newborn's mind. The student will be shown how this earliest level affects us throughout life.

The next level is the immature mind. At this stage the student will see how the mind is confused. It wants to cling to its feelings of omnipotence; however, it finds itself at the mercy of adults. The mind is an opportunist at this stage. Each student will be shown how much he/she is stuck at this level and how to get to the next level, the mature mind.

The mind at this level is well grounded. It is realistic and it respects its own self as well as others. The student will be taught how to master this level and how to get to the next level the super-mature or mastermind. At this level the mind sees the whole picture. It knows the bottom line of life. It likes all of humanity as one big family. Students will be shown why they all need to be at this level. They will be shown ways of how to feel and think like a master. Topics like: What I think I am and what I actually am and how I can bridge the gap will be taught.

Other topics like: If your self-image is distorted you work for your self-image. A clear mind works for you. How much of your emotional intelligence is an asset and how much of it is a liability. A clear mind creates health, wealth, wisdom and happiness. Everyone may not be a genius; but one can be close. Raw secrets for a successful life will be taught.

Another chapter will be devoted to the laws of Mother Nature. The first law is that God dos not give us birth. God gives us the chance to be born! The one that wins the sperm race is the one that gets the gift of life. Mother Nature has insured that everyone who is born is an incredible champion. Each student will be shown why he/she is an incredible champion with vast potential. Each student was a great champion and lets see what is stopping him/her from being one now. What changed between that first incredible victory and now. How can the student become a champion once again.

We will also teach the students that the goal is just the last part of the journey, emphasizing that the journey itself is the goal. Living a suprmature life itself is the goal. How we live every moment is what is important. The results are the icing on the cake; but the cake is far more important and how not to go through life ignoring life itself.

In our schools and colleges binge drinkings is very widespread. The students and the teachers look forward to it. Now there is evidence that excess alcohol destroys brain cells. We will have lessons on moderation when it comes to any activity especially alcohol. We sill also have anti-smoking and anti-drug lessons.

A realistic assessment of any situation results in improved chances for success. The students will be provided with the knowledge to make his/her mind the best trained receptacle for reality. They say that knowledge is power. The 4TH R will give the student the relevant knowledge to have the power to understand the bottom line of the rules of the game of life. It will provide the informal education that many students lack due to their own unhealthy upbringing. It will train the student to think and act like an expert.

My subject will turn out not just a great mathematician; but also a great human being. It will also provide the wisdom of the ages to create a well-rounded personality for each student. It will give each student the power to shape his/her own human identity and control his/her own destiny.

1. What I claim as my invention is that I have invented a new subject The 4TH R that teaches success. The 4TH R teaches emotional intelligence, enabling each student to master his own self.
